(19) United States
(12) Patent Application Publication
(10) Pub. No.: US 2026/0253410 A1
(43) Pub. Date: Aug. 27, 2026

(54) IDENTIFICATION PROCESSING METHOD AND SYSTEM FOR PLANT IMAGE, AND STORAGE MEDIUM

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 18/994,057

(22) PCT Filed: Jul. 12, 2023
(86) PCT No.: PCT/CN2023/106975

§ 371 Date: Jan. 14, 2025

(30) Foreign Application Priority Data
Aug. 3, 2022 (CN) 202210924926.4

(51) Int. Cl. G06V 20/10; G06V 10/771; G06V 10/82

(52) U.S. Cl. CPC G06V 20/188; G06V 10/771; G06V 10/82

(57) ABSTRACT

The present disclosure relates to an identification processing method and system for a plant image, and a storage medium. The method includes: acquiring an input image associated with a plant, and determining distinguishing features of the plant according to a trained image identification model, wherein the distinguishing features comprise classifications and growth stages of the plant; acquiring candidate images and labels corresponding to each of the candidate images, wherein the labels comprise classifications and growth stages of a plant in the candidate images; and selecting, from the candidate images, a candidate image having the corresponding label consistent with the distinguishing features as an output image to be displayed in a page.

### TECHNICAL FIELD

The present disclosure relates to the field of image identification technology, particularly to an identification processing method and system for plant images and a storage medium.

### DESCRIPTION OF RELATED ART

In the field of computer technology, applications for plant identification are available. These applications typically receive images from users (including static images, dynamic images, and videos) and utilize artificial intelligence-based image identification models to identify the classification and growth stage of the plant to be identified in the image. For instance, the identification result, namely the plant classification, may be the species of the plant, while the growth stage of the plant may include blooming period, leaf period, fruiting period, and so forth. The input images from users generally encompass at least a portion of the plant to be identified, such as the stem, leaves, and flowers of the plant to be identified.

In some current identification processing methods, the primary image displayed in the plant identification result page utilizes an aesthetically enhanced representation of the plant. However, the morphology of the plant depicted in the primary image might not correspond to the image captured by the user. For instance, in cases where the user has captured an image of an apple blossom, the primary image on the identification results page might depict an apple fruit instead. This inconsistency between the primary image in the identification results and the image captured by the user might potentially diminish the persuasiveness of the provided answer, thereby rendering it more challenging for the user to accept the accuracy of the plant identification.

### SUMMARY

The present disclosure provides an identification processing method and system for plant images and a storage medium.

According to the first aspect in an embodiment of this disclosure, an identification processing method for plant images is provided, including: acquiring an input image associated with a plant, and determining distinguishing features of the plant according to a trained image identification model, which includes classifications and growth stages of the plant; acquiring candidate images and labels corresponding to each of the candidate images, wherein the labels include the classifications and the growth stages of the plant in each of the candidate images; and selecting, from the candidate images, a candidate image having corresponding labels consistent with the distinguishing features as an output image to be displayed in a page.

According to the second aspect of an embodiment of this disclosure, an identification processing methods for plant images is provided, including: acquiring an input image associated with a plant, and determining distinguishing features of the plant according to a trained image identification model, which includes classifications and growth stages of the plant; acquiring candidate images and labels corresponding to each of the candidate images, wherein the labels include the classifications and the growth stages of the plant in each of the candidate images; and selecting, from the candidate images, a candidate image having corresponding labels including the classifications and the growth stages from the distinguishing features, as well as including the classifications from the distinguishing features and other growth stages different from the growth stages from the distinguishing features as an output image to be displayed in a page.

According to the third aspect of an embodiment of this disclosure, an identification processing system for plant images is provided, including: one or more processors; and one or more memories, which are configured to store a series of computer-executable instructions and computer-accessible data associated with the series of computer-executable instructions, wherein, when executed by the one or more processors, the series of computer-executable instructions enable the one or more processors to execute the identification processing method according to the first aspect or the second aspect.

According to the fourth aspect of an embodiment of this disclosure, a non-transitory computer-readable storage medium is provided, which stores a series of computer-executable instructions that, when executed by one or more computing devices, enable the one or more computing devices to execute the identification processing method according to the first aspect or the second aspect.

The advantage of the embodiments of this disclosure is that the disclosure provides an improved identification processing method for plant images, which may acquire more targeted identification result for display based on various factors such as the inherent attributes of the plant in the input image, including the classification and growth stage of the plant, as well as the user attributes of the image input when performing identification process on the input image.

Another advantage of the embodiments of this disclosure is that after performing identification process on the plant in the image, the disclosure provides images of the same plant at other growth stage while outputting the identification result, in order to provide users with a better identification experience, thereby reducing the user unsubscribe rate.

It may be understood that the above advantages do not need to be all realized in one or some specific embodiments, but may be partially distributed in different embodiments according to this disclosure. The embodiments according to this disclosure may have one or some of the above advantages, or may alternatively or additionally have other advantages.

Through the following detailed description of exemplary embodiments of this disclosure with reference to the accompanying drawings, other features and advantages of this disclosure will become clearer.

### BRIEF DESCRIPTION OF THE DRAWINGS

FIG. 1 is a schematic view showing an identification processing method for plants according to an embodiment of this disclosure.

FIG. 2 is a flowchart showing an identification processing method for plants according to an embodiment of this disclosure.

FIG. 3 is a flowchart showing the training of an image identification model for plants according to an embodiment of this disclosure.

FIG. 4 is another schematic view showing an identification processing method for plants according to an embodiment of this disclosure.

FIG. 5 is another flowchart showing an identification processing method for plants according to an embodiment of this disclosure.

FIG. 6A to FIG. 6C are schematic views showing an embodiment of an identification processing method for plants according to this disclosure.

FIG. 7 shows an exemplary configuration of an identification processing system according to an embodiment of this disclosure.

FIG. 8 shows an exemplary configuration of a computing device that may implement the embodiments according to this disclosure.

### DESCRIPTION OF THE EMBODIMENTS

The various exemplary embodiments of this disclosure will be described in detail below with reference to the accompanying drawings. It should be noted that unless otherwise specifically stated, the relative arrangement, numerical expressions, and numerical values of components and steps described in these embodiments do not limit the scope of this disclosure.

The following description of at least one exemplary embodiment is actually only illustrative and is not to be construed as any limitation on this disclosure and its application or use. That is to say, the structures and methods in this specification are shown in an exemplary manner to illustrate different embodiments of the structures and methods in this disclosure. However, those skilled in the art will understand that they merely illustrate exemplary ways that may be used to implement this disclosure, rather than exhaustive ways. Furthermore, the drawings need not be drawn to scale, and some features may be enlarged to show details of specific components.

Technologies, methods, and devices known to ordinary skilled persons in the related field may not be discussed in detail, but in appropriate circumstances, said technologies, methods, and devices should be considered as part of the granted specification.

It should be noted that the embodiments in the present disclosure use plants as the object for image identification, which does not imply that the disclosed technical solutions are limited to the identification of plant images. In general, the present disclosure has conducted in-depth research on methods and systems for object identification. To simplify the description, plants are used as examples of objects in the following exemplary embodiments, but it should be realized that the “object” in this disclosure includes, but is not limited to, animals, people, scenery, natural objects, buildings, commodities, food, medicines, and/or daily necessities.

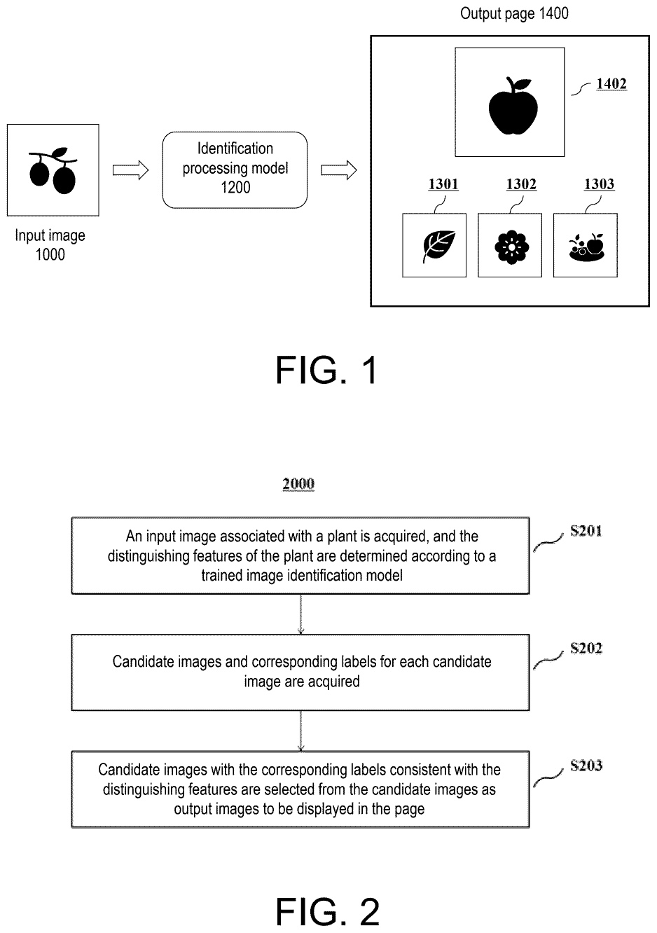

FIG. 1 is a schematic view showing an identification processing method for plants according to an embodiment of this disclosure. As shown in the figure, a user uses this identification processing method to perform image identification process on the plant contained in the input image 1000. First, the input image 1000 is input into the identification processing model 1200 for plant images. This model 1200 has been pre-trained with data to achieve an accuracy level and may be used to identify the plant species and other information contained in the input image 1000. Subsequently, based on the identified information, further processing is performed to acquire the output page 1400, which may include the output image 1402 selected from a series of candidate images as the result (in some embodiments, the page 1400 may also include output images 1301, 1302, 1303).

In a non-limiting embodiment, the user uses the identification processing method in the present disclosure to acquire information related to the object (plant) to be identified, for example, information about the plant's classification, growth location, growth stage or season and so on that the user is interested and wishes to know. The input image 1000 may be captured by the user in real-time, or read from a pre-stored database in a storage device, or acquired online through wired/wireless network communication. The user may capture images using imaging devices such as cameras or lenses built into portable devices, or transmit images through communication with portable devices after imaging by other external devices. Furthermore, the input image 1000 may include any form of visual presentation, such as static images, dynamic images, and videos.

The input image 1000 subsequently enters the trained identification processing model 1200. In the exemplary embodiment of the present disclosure, the model 1200 is a plant identification model. When the object to be identified is of other types, the corresponding model adopted may be an identification processing model for other types of objects. The identification processing model 1200 may include multiple identification models categorized according to geographical regions. For example, geographical regions may be categorized according to large areas such as North America, East Asia, Europe, etc., or according to small areas such as the Yangtze River Delta, Pearl River Delta, Northwest region of China, etc. In a non-limiting example, different identification models may be invoked according to the growth location (i.e., location information) of the plant to be identified. For instance, the identification models for the United States and China are different image identification models trained using different plant samples from their respective geographical regions.

The identification processing model 1200 first determines the object contained in the input image 1000. When it is identified that the object belongs to a plant, the process enters subsequent processing steps; if the identified object does not include a plant, an error prompt is given to notify the user to re-input the image or adjust the image area to be identified. Since plant images acquired by users usually have background objects, or there may be partial areas of other plants around the plant to be identified in the image, methods such as multi-object detection or mask-renn may be adopted to accurately locate the area of the plant to be identified in the image for further identification by the identification model.

Subsequently, for the input image 1000 where the identified object belongs to a plant, the identification processing model 1200 further determines the distinguishing features of the plant. Distinguishing features refer to personalized information that distinguishes the plant in the image from other types of plants or plants in other growth stages, including but not limited to general information such as the plant's biological classification, common name, popular varieties, as well as specific information about the captured part of the plant itself, the plant's current growth stage, the season when the plant is captured, and the location of the plant's growth site. Specifically, the biological classification of plants includes seven main ranks: kingdom, phylum, class, order, family, genus, and species. The captured parts include main constitutions such as trunk, buds, seeds, flower buds, fruits, and seedlings. The current growth stages include a just-emerged seedling stage, a small seedling stage, a leaf stage, a blooming stage, a fruiting stage, a leaf-falling stage, and a dormant stage. The season when the plant is captured includes spring, summer, autumn, winter, or the 24 solar terms. The location of the growth site may be determined by location information autonomously uploaded by the user or acquired through communication between the imaging device and portable device.

In some embodiments, the output classification ranks may be determined based on the identified plant part in the image. In some cases, if the plant part in the image is a trunk, bud, seed, flower bud, fruit, or seedling, it might be more difficult to obtain accurate species information (i.e., information indicating that the classification rank is species). In these cases, directly outputting species as the identification result is likely to be incorrect, which might mislead or confuse the user. However, at this time, outputting genus as the identification result is generally more accurate. If the plant part in the image is a leaf, flower, stem, root, or other characteristic part, the identified species information is usually reliable. Therefore, in response to the plant part in the image being one of trunk, bud, seed, flower bud, fruit, and seedling, the output classification rank is determined to be genus; and in response to the plant part in the image being one of leaf, flower, stem, and root, the output classification rank is determined to be species.

The identification results provided by the plant identification model usually include one or more classifications of the identified plant. One or more classifications are arranged in descending order of confidence (the degree of confidence that the classification is close to the true classification). In an embodiment, the classification rank of one or more classifications included in the identification results provided by the plant identification model is species. The classifications with a classification rank of genus for each identification result may be acquired based on the correspondence between species and genus. In an embodiment, the classification rank of one or more classifications included in the identification results provided by the plant identification model is species and genus.

In the case where distinguishing features have been determined, images corresponding to the plant contained in the input image 1000 are selected from pre-stored candidate images. In the pre-established database of candidate images, a series of candidate images include, for example, candidate images displaying the plant's leaves, candidate images displaying the plant's flowers, and candidate images displaying the plant's fruits. It should be noted that the listed candidate images are exemplary rather than limiting. In other embodiments, one or more candidate images may be pre-stored for each part of at least one part of the plant, or candidate images may be selectively pre-stored for important parts/growth stages.

In some embodiments, one or more candidate images may be pre-stored for popular growth stages of some plant classifications. Popular growth stages may be determined based on the number of times each growth stage of the classification is identified in historically identified input images. For example, growth stages with identification counts being greater than a threshold may be determined as popular growth stages. These historically identified input images may include only the current user's historical identification data, or may include other users' historical identification data. A threshold for evaluating whether a growth stage is popular is preset. If the number of identifications for a growth stage of the classification is greater than the preset threshold, the growth stage may be considered representative for that plant classification, and may be determined as a popular growth stage for the plant classification.

In some embodiments, one or more candidate images may be pre-stored for robust identification features of some plant classifications. Robust identification features of a plant may be important parts or growth stages of the plant. For example, for succulent plants, leaves/leaf stage may serve as robust identification features of the plant; for example, for cultivated blooming plants, blossoming/blooming stage may serve as robust identification features of the plant, etc.

Alternatively, at least one sample image may be pre-stored for each classification of plants in the candidate images, including local images for at least one part of the plant or overall images for the whole plant. Alternatively, the plants contained in each image of the candidate images may have different classifications, growth stages and/or parts. The number of candidate images corresponding to these different labels may be the same or different.

On the other hand, labels corresponding to each image in the candidate images are pre-stored simultaneously with the pre-stored candidate images. The information contained in these labels is associated with the distinguishing features of the input image 1000, including but not limited to one or more of the exclusive information such as the biological classification of the plant therein, common name, popular variety, and the captured part of the image, the growth stage, the season when the plant is captured, the location of growth, etc. Based on the above, the labels corresponding to the candidate images are matched with the distinguishing features of the input image 1000, and then the candidate images having the corresponding labels consistent with the distinguishing features of the plant contained in the input image 1000 is selected from the candidate images as the output image 1402.

It should be noted that the different information included in the above-mentioned distinguishing features of the input image 1000 (such as growth location, part, current season) and the exclusive information included in the labels of the candidate images are only exemplary. That is, in different implementations, the distinguishing features of the input image 1000 do not include all types of exclusive information, but only include one or several of exclusive information. The types of information included in the labels of the candidate images correspond to the distinguishing features of the input image 1000.

In a non-limiting embodiment, the candidate images and their corresponding labels are pre-stored in association in a database. This database may be a content management system (CMS), which may submit, modify, publish, etc. content such as text files, images, data in databases, tables, etc. The database may assist the WEB front-end to provide content to users in a personalized way, that is, provide a personalized portal framework to better push content to users. In the embodiments of this disclosure, such a database may store descriptive content of plants and their distinguishing features and/or labels. These descriptive contents may be textual or pictorial, for example, they may include various fields, articles, etc., so that users may extract and output information about plant classifications, growth stages, growth locations, etc. from the descriptive contents.

In another non-limiting embodiment, if the input image 1000 shows a plant (or plant part), and the distinguishing features associated with this input image 1000 include location information related to the captured image, while also acquiring corresponding information that the image is captured in the region of a first production area, then it is necessary to match labels involving regions in the candidate images. For example, images associated with labels of growth locations in and around the first production area are retrieved as output images from the database where candidate images and their labels are pre-stored. In other words, when a user uses the identification processing method of the present disclosure, after the identification processing model identifies and subsequently processes the input image 1000, images of the current location where the image is captured or the associated location in the image used may be displayed in the output page 1400.

In yet another non-limiting embodiment, if the input image 1000 shows a plant (or plant part), and the distinguishing features associated with this input image 1000 include season information related to the captured image, while also acquiring related information that the image is captured in autumn or the current time of executing the identification process is autumn, then it is necessary to match labels involving autumn in the candidate images. For example, taking the input image 1000 in FIG. 1 as an example, the image shows the fruit of an apple. Based on the distinguishing features of the apple such as growth stage, it may be determined that the image is captured in autumn when the fruit is ripe. Then, after identification and subsequent processing through the image identification model, images associated with labels involving autumn for different parts of this plant may be displayed in the output page 1400.

In yet another non-limiting embodiment, the output image 1402 may be determined based on the proportion (such as area ratio, pixel ratio, etc.) of the plant's various parts occupying the area of the user's input image 1000. Known computer vision techniques may be used to determine the proportion of the area occupied by various parts of the plant in the input image 1000, the proportions of each part is scaled to determine a range, and images, where the proportions of areas occupied by various parts of the corresponding plant in the candidate images fall within this range, are selected from the candidate images as the output image 1402. For example, if the apple blossom occupies 50% of the area and the leaves occupy 25% of the area in the user's input image 1000, the proportions of each part may be scaled by 20%, then images, where the proportion of the area occupied by apple blossoms is within the range of 40% to 60% and the proportion of the area occupied by leaves is within the range of 20% to 30%, may be selected from the candidate images. It should be understood that in such an embodiment, the labels corresponding to the pre-stored candidate images may include information about the proportions of area occupied by various parts of the plant in the corresponding candidate images. Based on this, images with proportions of various parts indicated by the labels corresponding to the candidate images within the aforementioned range may be selected as the output image 1402.

In some embodiments, the output page 1400 may include multiple output images determined based on the results of the identification processing model 1200, such as a main output image 1402 that is displayed more prominently in the page 1400, and one or more secondary output images 1301, 1302, and 1303 that are displayed less prominently in the page 1400. The prominent display and less prominent display may be distinguished by the display size of the images in the page. For instance, the size of the main output image is larger than that of the secondary output images. The prominent display and less prominent display may also be distinguished by whether the display of the image in the page is default or not. For example, the main output image may be displayed by default, while the secondary output images may be displayed upon receiving a specific operation.

In some embodiments, the main output image 1402 may be an candidate image selected from the candidate images having the corresponding label consistent with the distinguishing features (such as classification and growth stage) of the identified input image. The secondary output images 1301, 1302, and 1303 may be candidate images selected from the candidate images having the corresponding labels including the classification from the distinguishing features of the input image but not including the growth stage from the distinguishing features. In cases where there are multiple secondary output images, the display sequence of each secondary output image may be arranged, for example, by arranging the images determined to be displayed with priority in the front. Images containing the aforementioned popular growth stages or robust identification features may be determined as images to be displayed with priority.

In another non-limiting embodiment, in response to none of the labels corresponding to the candidate images whose labels include the classification from the distinguishing features contain the growth stage from the distinguishing features, that is, when there are no pre-stored images in the candidate images that embody the growth stage in the input image 1000, the input image 1000 itself may be displayed as the output image 1402 in the page 1400.

In a non-limiting embodiment, the display page further has multiple similar images selected from the candidate images associated with the input image 1000, where the labels corresponding to the similar images include classifications similar to the classification from the distinguishing features. For example, when the plant contained in the input image 1000 is classified as a sunflower, images including daisies, which belong to the same Asteraceae family, may be similar images corresponding to the identification result. Generally, compared to the output images 1402 and 1301 to 1303, the similar images are displayed less prominently in the display page 1400. Specifically, multiple similar images need to be arranged and displayed in a predetermined sequence. The predetermined sequence of similar images is determined depending on whether their corresponding labels include the growth stage from the distinguishing features. Similar images that include the corresponding growth stage are arranged to be displayed with priority among the multiple similar images.

In another non-limiting embodiment, the output page 1400 may be the first page presented by default, that is, the default output page displayed to the user after the identification process. In addition to the first page, there may be multiple other pages, such as a second page displaying the second output image. In response to a specific user operation, the display page switches from the default first page to present the second page. The second output image includes images selected from the candidate images having the corresponding labels including the classification from the distinguishing features and including other growth stages different from the growth stage from the distinguishing features. That is, compared to the default output image, the second output image may display different growth stages of the identified plant, allowing users to obtain identification results and related information through switching. The user's specific operation is mainly performed in the operable region corresponding to a specific growth stage in the first page, including information interaction with one or more input devices such as keyboard, mouse, touch screen, microphone, etc. Furthermore, the second page may further display multiple images, such as second similar images, having the corresponding labels including classifications similar to the classification from the distinguishing features and including the aforementioned specific growth cycle, which are displayed less prominently in the second page compared to the second output image. As mentioned earlier, the display page defaults to showing the first page corresponding to the “Now” tab before receiving other indications or operations from the user. For example, based on the sunflower identification result, the current main output image is displayed by default. In response to the user operation to switch to the second page displaying secondary output images, for example, when the user clicks the “Blooming” tab to display a blooming image of the sunflower, or clicks the “Fruit” tab to display an image of the sunflower's fruit.

Specifically, FIG. 1 shows a non-limiting embodiment according to the present disclosure, wherein the input image 1000 displays a fruit of an apple, which, after undergoing the identification processing method of the present disclosure, results in distinguishing features including apple as the classification, and fruit as the growth stage/part. From a series of candidate images, an output image 1402 is selected with labels consistent with the above distinguishing features, namely, also including “apple” and “fruit”. Alternatively, in the output page 1400, the output image 1402 is displayed prominently as the main output image with a larger size. In addition, the page 1400 also displays secondary output images with smaller sizes in a less prominent manner, for example, the output image 1301 including apple leaves, the output image 1302 including apple flowers, and the output image 1303 including apple fruits. That is, the user inputs an image 1000 of an apple fruit through the identification processing method of the present disclosure, and outputs various output images corresponding to the input image 1000 through the trained identification processing model 1200.

The identification processing model 1200 may include any known method for plant identification based on images. For example, the plant to be identified in the image may be identified through a computing device and a trained plant image identification model to obtain the identification result, that is, the classification of the plant. The image identification model may be established based on neural networks (such as deep convolutional neural networks (CNN) or deep residual networks (ResNet), etc.). The training process for the identification processing model 1200 will be described in detail later.

In an example, the identification processing model 1200 adopts a convolutional neural network model. The convolutional neural network model is a deep feedforward neural network that uses convolution kernels to scan plant images, extract features to be identified from the plant images, and then identify the features to be identified for the plants. Additionally, in the process of identifying plant images, the original plant images may be directly input into the convolutional neural network model without the need for pre-processing the plant images. Compared to other identification models, the convolutional neural network model possesses higher identification accuracy and efficiency.

In another example, the identification processing model 1200 adopts a residual network model. Compared to the convolutional neural network model, the residual network model has an additional identity mapping layer, which may avoid the phenomenon of accuracy saturation or even decline caused by convolutional neural networks as the network depth (the number of stacked layers in the network) increases. The identity mapping function in the identity mapping layer of the residual network model needs to satisfy: the sum of the identity mapping function and the input of the residual network model equals the output of the residual network model. After introducing the identity mapping, the changes in the output of the residual network model become more apparent, therefore it may greatly improve the identification accuracy and efficiency of plant growth stage identification, thereby enhancing the identification accuracy and efficiency of plants.

The following will explain the identification processing method 2000 for plants according to an embodiment of this disclosure in conjunction with FIG. 2. Specifically, in step S201, an input image associated with a plant is acquired, and the distinguishing features of the plant, including the classification and growth stage of the plant, are determined according to a trained image identification model. Then, in step S202, candidate images and corresponding labels for each of the candidate images are acquired, wherein the label includes the classification and growth stage of the plant in each candidate image. Subsequently, in step S203, candidate images with the corresponding labels consistent with the distinguishing features are selected from the candidate images as output images to be displayed in the page.

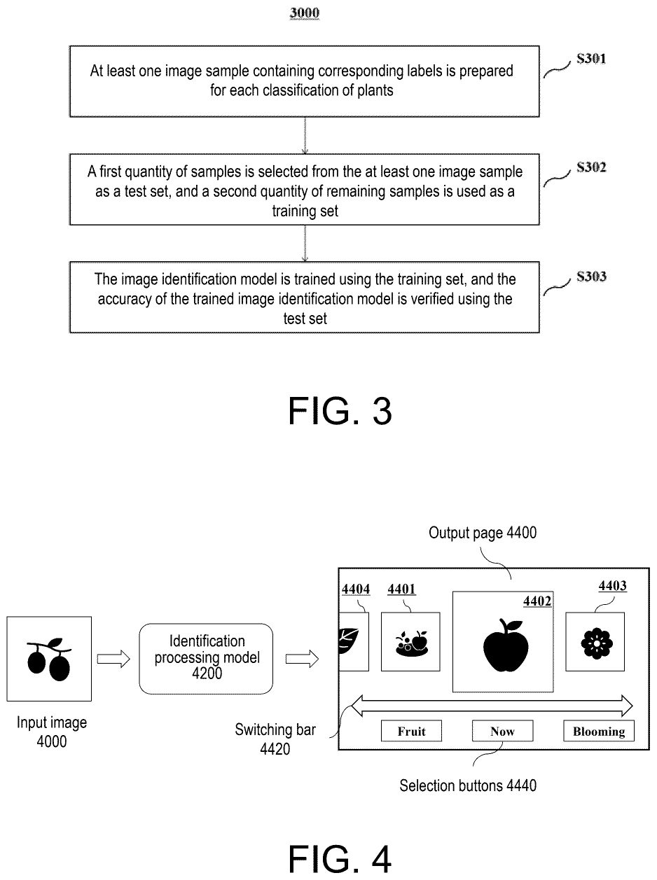

FIG. 3 illustrates a flowchart for training an image identification model for plants according to an embodiment of this disclosure. It should be noted that the following embodiment provides an image model for identifying plant classifications, but the technical solution of the present disclosure is not limited to this, and the present disclosure may also be used for other scenarios such as identifying plant growth stages. As shown in FIG. 3, first, in step S301, at least one image sample containing corresponding labels is prepared for each classification of plants. Then, in step S302, a first quantity of samples is selected from the at least one image sample as a test set, and a second quantity of remaining samples from the at least one image sample is used as a training set. Subsequently, in step S303, the image identification model is trained using the training set, and the accuracy of the trained image identification model is verified using the test set.

Specifically, the at least one image sample in step S301 includes images of plants for each classification and their associated labels, the labels include the growth stages, parts, and growing locations related to the plants in the images. The number of images for plants in each classification may be equal or unequal. The selection of test sets and training sets in step S302 may be performed manually or automatically and randomly by hardware devices or software programs. The first quantity corresponding to the test set accounts for 5% to 20% of the total number of all image samples. In the verification of step S303, if the accuracy is greater than or equal to a preset accuracy, the training ends. When the verification accuracy is less than the preset accuracy, a third quantity of image samples may be prepared for each plant classification to retrain the image identification model. Alternatively, the proportion of the first quantity to the second quantity may be adjusted to retrain the image identification model. After training the image identification model, the proportion of the first quantity to the second quantity may be adjusted based on the verification results of the training, that is, adjusting the proportion of the test set to the total number of all image samples.

FIG. 4 illustrates another schematic view of the identification processing method for plants according to an embodiment of this disclosure. For brevity, the steps that are repeated in the identification processing method shown in FIG. 1 will not be described again here, and only the differences between this method and FIG. 1 will be described.

As shown in the figure, the user uses this identification processing method to perform image identification processing on the plant contained in the input image 4000. First, the input image 4000 is input into the identification processing model 4200 for plant images, which has been pre-trained with data to achieve an accuracy level and may be used to identify the plant species and other information contained in the input image 4000. Subsequently, based on the identified information, further processing is conducted to obtain the output page 4400, which includes output images 4401, 4402, and 4403.

Specifically, the main difference between the identification processing method in FIG. 4 and the method in FIG. 1 is the output page 4400 after image identification. After the input image 4000 enters the identification processing model 4200, the distinguishing features of the plant contained therein are identified, wherein the distinguishing features at least include the classification and growth stage of the plant. Based on the obtained distinguishing features, labels corresponding to the plant's classification and growth stage are determined, thereby selecting images corresponding to these labels from the candidate images. Each output image in the output page 4400 is configured to be operable to change its display position in the page.

The output images may include a currently displayed image 4402 that is prioritized for display and other images 4401, 4403, and 4404 that are displayed in response to specific operations. The current image 4402 may be an output image selected from the candidate images having the corresponding labels including the classification and growth stage from the distinguishing features. The other images 4401, 4403, and 4404 may be output images selected from the candidate images having the corresponding labels including the classification from the distinguishing features and other growth stages different from the growth stage from the distinguishing features. If none of the labels corresponding to the candidate images whose labels include the classification from the distinguishing features contain the growth stage from the distinguishing features, then the input image 4000 will be displayed as the current image in the output page 4400. Among the multiple other images 4401, 4403, and 4404, images that include popular growth stages and/or robust identification features of the respective plant classification may be prioritized for display, for example, by being arranged to display near the current image 4402 (e.g., images 4401 and 4403 are displayed with higher priority compared to image 4404).

FIG. 4 illustrates a non-limiting embodiment of the present disclosure, wherein the input image 4000 displays a fruit of an apple, and the distinguishing features obtained through the identification processing model 4200 include apple (classification) and fruit (growth stage/part). In this case, the selected output images from the candidate images include the output image 4401 (“apple”, “fruit”), the output image 4402 (“apple”, “fruit”), the output image 4403 (“apple”, “flower”), and the output image 4404 (“apple”, “leaf”), all of which contain “apple”. In addition to the series of output images mentioned above, the page 4400 further includes a switching bar 4420 for switching between different candidate images. In response to input signals communicated through input devices including but not limited to mouse, keyboard, touch screen, etc., the switching bar 4420 is configured to switch the primarily displayed candidate image according to the input signal (such as user's click or swipe operation) in the direction of the display interface. Alternatively, the display interface may further include selection buttons 4440, such as “Fruit”, “Now”, and “Blooming” buttons, to facilitate user selection for viewing the corresponding growth stages/parts of the identified plant.

Specifically, the display method of the output images obtained after the identification process may be similar to the steps of method in FIG. 1, or an active switching method may be adopted. That is, images with growth stages similar to the user's input image 4000 may be prioritized for display; alternatively, it may be set for the user to switch the displayed images through the switching bar 4420 and selection buttons 4440. In a non-limiting embodiment, when the user selects to switch to the “Blooming” button in preview mode, the first image in the current mode will be an image of the identified plant in bloom. At this point, clicking on the corresponding image may enter the preview mode, where the blooming image is the first in the current sequence, followed by multiple similar images for user reference. These similar images may be sorted according to the growth stage corresponding to the currently switched button, or the similar images may be in a default sequence.

Similar to the embodiment in FIG. 1, the candidate images and associated labels may be pre-stored in a database. In a non-limiting embodiment, in a non-limiting embodiment, robust identification features associated with growth stages may be pre-set for plants of each classification, wherein the robust identification features are used to label representative growth stages for plants of that classification, thereby determining the display sequence of candidate images.

Alternatively, the user unsubscription rate at each growth stage of the plant may be statistically analyzed. Unsubscription refers to users no longer subscribing to or using one or more functions of the application (APP) that provides the method of this disclosure. The unsubscription rates vary during different growth periods of the plant, generally, the unsubscription rate for leaves>the unsubscription rate for flowers>the unsubscription rate for fruits. The unsubscription rate reflects whether users have long-term interests in identifying a plant. To better retain users, in addition to displaying the main image corresponding to the current growth state on the identification result page, main images (such as images of the plant's blooming state and fruiting state) corresponding to growth states with lower unsubscription rates may also be displayed to users on the identification result page. Specifically, a second threshold is preset for the user unsubscription rate. If the user unsubscription rate for a plant classification is lower than the second threshold, i.e., the rate at which users cancel subscriptions is low, meaning users are interested in the part/growth stage of the currently identified plant. In this case, it is determined that the part/growth stage of interest to users in the output image 4400 is prioritized in the display arrangement.

Alternatively, if the identification processing model 4200, during the process of identifying the input image 4000, is unable to select an image from the candidate images with a label consistent with the distinguishing feature based on identifying the distinguishing feature of the input image 4000, for example, when the database having pre-stored candidate images and their labels does not include images associated with the classification, growth stage, part, etc. of the plant in the input image 4000, it is not possible to use existing candidate images as output results. In this case, the input image 4000 is directly output as the identification result (i.e., output image).

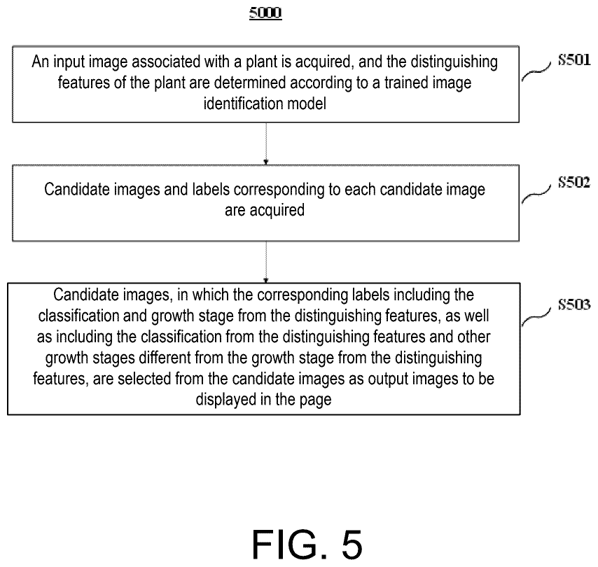

FIG. 5 illustrates another flowchart of an identification processing method for plants according to an embodiment of this disclosure. In step S501, an input image associated with a plant is acquired, and the distinguishing features of the plant are determined according to a trained image identification model. Then, in step S502, candidate images and labels corresponding to each of the candidate images are acquired. Subsequently, in step S503, candidate images, in which the corresponding labels including the classification and growth stage from the distinguishing features, as well as including the classification from the distinguishing features and other growth stages different from the growth stage from the distinguishing features, are selected from the candidate images as output images to be displayed in the page.

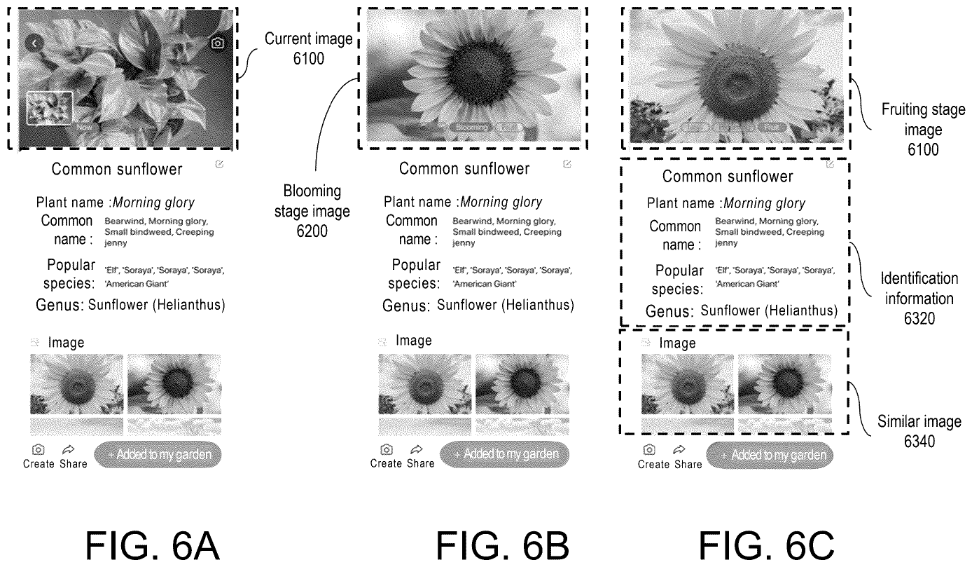

FIG. 6A to FIG. 6C illustrate schematic views of an embodiment of an identification processing method for plants according to this disclosure. FIG. 6A to FIG. 6C respectively show the identification result pages based on an embodiment of the present disclosure, wherein FIG. 6A shows the current image 6100 that the user needs the assistance of the system to identify, FIG. 6B shows the blooming stage image 6200 (“Blooming” button) selected for display based on the distinguishing features such as classification, part/growth stage identified from the current image 6100, and FIG. 6C shows the fruiting stage image 6300 (“Fruit” button) selected for display based on the aforementioned distinguishing features.

Taking FIG. 6C as an example, the distinguishing features identified based on the input image (current image) 6100 are reflected in the identification information 6320, which includes but is not limited to the plant name, common name, popular variety, and genus. Moreover, in the exclusive identification result page for the current plant, in addition to the fruiting stage image 6300 as the output image, a similar image 6340 is also displayed, thereby providing users with more reference information with regard to the current plant.

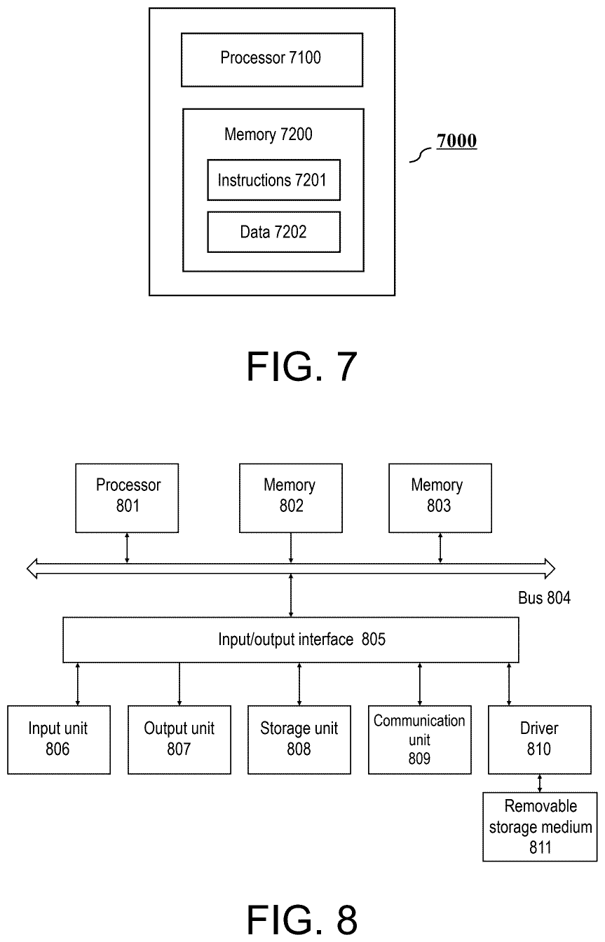

FIG. 7 shows an exemplary configuration of an identification processing system according to an embodiment of this disclosure. As shown in FIG. 7, an identification processing system 7000 may include a processor 7100 and a memory 7200, wherein instructions are stored in the memory 7200, and when the instructions are executed by the processor 7100, the steps in the identification processing method as described above may be implemented.

The processor 7100 may execute various actions and processing according to instructions stored in the memory 7200. Specifically, the processor 7100 may be an integrated circuit chip with signal processing capability. The aforementioned processor may be a general-purpose processor, a digital signal processor (DSP), an application-specific integrated circuit (ASIC), a field-programmable gate array (FPGA) or other programmable logic devices, discrete gates or transistor logic devices, discrete hardware components, capable of implementing or executing various methods, steps, and logic diagrams disclosed in the embodiments of this disclosure. The general-purpose processor may be a microprocessor or the processor may also be any conventional processor, etc., and may be an X86 architecture or an ARM architecture, etc.

The memory 7200 stores executable instructions 7201 and data 7202. The instructions 7201 are executed by the processor 7100 to perform the identification processing method described above. The memory 7200 may be volatile memory or non-volatile memory, or may include both volatile and non-volatile memory. Non-volatile memory may be read-only memory (ROM), programmable read-only memory (PROM), erasable programmable read-only memory (EPROM), electrically erasable programmable read-only memory (EEPROM), or flash memory. Volatile memory may be random access memory (RAM), which serves as external cache. By way of illustration and not limitation, many forms of RAM are available, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchronous link dynamic random access memory (SLDRAM), and direct Rambus random access memory (DR RAM). It should be noted that the memory of the method described herein is intended to include, but is not limited to, these and any other suitable types of memory.

In some embodiments, the identification processing system 7000 may also be configured to identify the input image to acquire multiple candidate images. In other words, the identification of the input image and the screening of the candidate images obtained from the identification may be implemented by the same identification processing system 7000.

In some embodiments, the identification processing system 7000 may be configured for plant identification. Of course, in some other embodiments, the identification processing system 7000 may also be configured to identify other types of objects.

FIG. 8 shows an exemplary configuration of a computing device that may implement the embodiments according to this disclosure. The computing device includes one or more processors 801, an input/output interface 805 connected to the processor 801 via a bus 804, and memories 802 and 803 connected to the bus 804. In some embodiments, the memory 802 may be read-only memory (ROM), and the memory 803 may be random access memory (RAM).

The processor 801 may be any kind of processor, and may include but is not limited to one or more general-purpose processors or special-purpose processors (such as dedicated processing chips). The memories 802 and 803 may be any non-transitory and data storage-implementable storage devices, and may include but are not limited to disk drives, optical storage devices, solid-state memories, floppy disks, flexible disks, hard drives, magnetic tapes or any other magnetic medium, compact discs or any other optical medium, cache memories and/or any other storage chips or modules, and/or any other medium from which a computer can read data, instructions and/or code.

The bus 804 may include but is not limited to Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, etc.

In some embodiments, the input/output interface 805 is connected to the following units: an input unit 806 configured with input devices such as a keyboard and a mouse for users to input operation commands, an output unit 807 that outputs processing operation screens and processing result images to a display device, a storage unit 808 including hard disk drives, etc. for storing programs and various data, and a communication unit 809 including a local area network (LAN) adapter, etc. and performing communication processing via the Internet as the representative network. Furthermore, a driver 810 is also connected, which reads data from and writes data to a removable storage medium 811.

The various aspects, implementations, specific implementations or features of the aforementioned embodiments may be used individually or in any combination. The various aspects of the aforementioned embodiments may be implemented by software, hardware, or a combination of hardware and software.

For example, the aforementioned implementations may be embodied as computer-readable code on a computer-readable medium. The computer-readable medium is any data storage device that is able to store data which may be thereafter read by a computer system. Examples of the computer-readable medium include read-only memory, random access memory, CD-ROMs, DVDs, magnetic tapes, hard disk drives, solid state drives, and optical data storage devices. The computer-readable medium may also be distributed in network-coupled computer systems so that the computer-readable code is stored and executed in a distributed manner.

For example, the aforementioned implementations may take the form of hardware circuits. The hardware circuits may include any combination of combinational logic circuits, clock storage devices (such as flip-flops, triggers, latches, etc.), finite state machines, memories such as static random access memory or embedded dynamic random access memory, custom designed circuits, programmable logic arrays, etc.

In an implementation, the hardware circuits according to the present disclosure may be realized by encoding and designing one or more integrated circuits using a hardware description language (HDL) such as Verilog or VHDL, or by combining the use of discrete circuits.

In the specification and claims, the phrase “A or B” refers “A and B” as well as “A or B”, and does not exclusively refer to only “A” or only “B”, unless otherwise specifically stated.

In this disclosure, references to “an embodiment”, “some embodiments” mean that the features, structures, or characteristics described in connection with the embodiment are included in at least one embodiment, at least some embodiments of the present disclosure. Thus, the appearances of the phrases “in an embodiment”, “in some embodiments” in various places throughout this disclosure are not necessarily all referring to the same embodiment or the same set of embodiments. Furthermore, the features, structures, or characteristics may be combined in any suitable combination and/or sub-combination in one or more embodiments.

As used herein, the word “exemplary” means “serving as an example, instance, or illustration” and not as a “model” to be precisely replicated. Any implementation described herein as exemplary is not necessarily to be construed as preferred or advantageous over other implementations. Moreover, the present disclosure is not limited by any theory expressed or implied in the above technical field, background, summary, or detailed description.

Additionally, some terminology may be used in the following description for reference purposes only and therefore is not intended to be limiting. For example, words such as “first”, “second”, and other such numerical terms referring to structures or elements do not imply a sequence or order unless clearly indicated by the context. It should also be understood that when used in this document, the word “include/comprising” specifies the presence of stated features, integers, steps, operations, units and/or components, but does not preclude the presence or addition of one or more other features, integers, steps, operations, units and/or components, and/or groups thereof.

In this disclosure, the terms “component” and “system” are intended to refer to a computer-related entity, either hardware, a combination of hardware and software, software, or software in execution. For example, a component may be, but is not limited to, a process running on a processor, an object, an executable state, a thread of execution, and/or a program, etc. By way of illustration, both an application running on a server and the server itself may be a component. One or more components may reside within a process and/or thread of execution, and a component may be localized on one computer and/or distributed between two or more computers.

Those skilled in the art should be aware that the boundaries between the above operations are merely illustrative. Multiple operations may be combined into a single operation, a single operation may be distributed among additional operations, and operations may be executed at least partially overlapping in time. Moreover, candidate implementations may include multiple instances of particular operations, and the order of operations may be altered in various other embodiments. However, other modifications, variations and substitutions are also possible. Therefore, this specification and drawings should be regarded as illustrative rather than limiting.

Although some specific embodiments of the present disclosure have been described in detail through examples, those skilled in the art should understand that the above examples are for illustration purposes only, and not for limiting the scope of the disclosure. The embodiments disclosed herein may be combined in any way without departing from the spirit and scope of this disclosure. Those skilled in the art should also understand that various modifications may be made to the embodiments without departing from the scope and spirit of this disclosure. The scope of the disclosure is defined by the appended claims.

1. An identification processing method for plant images, comprising:
acquiring an input image associated with a plant, and determining distinguishing features of the plant according to a trained image identification model, the distinguishing features comprising classifications and growth stages of the plant;
acquiring candidate images and labels corresponding to each of the candidate images, wherein the labels comprise the classifications and the growth stages of the plant in the each of the candidate images; and
selecting, from the candidate images, a candidate image having corresponding labels consistent with the distinguishing features as output images to be displayed in a page.

2. The identification processing method according to claim 1, further comprising:
pre-establishing a database of the candidate images, wherein at least one sample image is comprised in each of the classifications of the plant in each of the candidate images, the at least one sample image comprises local images for at least one part of the plant or overall images for a whole plant.

3. The identification processing method according to claim 1, wherein:
the candidate images and the corresponding labels thereof are pre-stored in association with each other in a database.

4. The identification processing method according to claim 1, wherein:
the distinguishing features further comprise at least one feature from among a growth location, a part, and a current season of the plant, and the labels comprise at least one corresponding to the at least one feature from among the growth location, the part, and the current season of the plant in corresponding candidate images.

5. The identification processing method according to claim 4, wherein:
acquiring current region information associated with the input image; and
retrieving labels comprising the growth location corresponding to the current region information from a database according to the current region information, and determining the candidate images associated with the labels as the output images.

6. The identification processing method according to claim 4, wherein:
acquiring current season information associated with the input image; and
retrieving labels comprising a current season corresponding to the current season information from a database according to the current season information, and determining the candidate images associated with the labels as the output images.

7. The identification processing method according to claim 1, further comprising:
pre-establishing a database of the candidate images, wherein at least one sample image corresponding to a popular growth stage is comprised in each of the classifications of the plant in each of the candidate images, the popular growth stage is determined based on the number of times each of the growth stages of the classifications is identified in each of historically identified input images.

8. The identification processing method according to claim 7, wherein:
the growth stages with the number of times being identified greater than a threshold are determined as the popular growth stage.

9. The identification processing method according to claim 1, further comprising:
pre-establishing a database of the candidate images, wherein at least one sample image corresponding to a robust identification feature of the classifications is comprised in each of the classifications of the plant in each of the candidate images.

10. The identification processing method according to claim 1, further comprising:
in response to none of the labels corresponding to each of the candidate images whose the labels comprise the classifications from the distinguishing features contain the growth stages from the distinguishing features, the input image is used as the output image.

11. The identification processing method according to claim 1, wherein the output images are main output images that are displayed more prominently in the page, and the method further comprises:
selecting, from the candidate images, one or more secondary output images with corresponding labels comprising the classifications from the distinguishing features but not comprising the growth stages from the distinguishing features, and the secondary output images being displayed less prominently in the page.

12. The identification processing method according to claim 1, further comprising:
selecting, from the candidate images, a plurality of similar images for display in the page, wherein labels corresponding to the similar images comprise the classifications similar to the classifications from the distinguishing features, and the similar images are displayed less prominently in the page compared to the output image,
wherein the similar images having the corresponding labels comprising the growth stages from the distinguishing features are arranged to be displayed with priority among the plurality of similar images.

13. The identification processing method according to claim 1, wherein the page is a first page presented by default, the method further comprising:
further presenting a second page in response to a specific operation, wherein a second output image is displayed in the second page, the second output image comprises images that are selected from the candidate images and having the corresponding labels comprising the classifications from the distinguishing features and comprising other growth stages different from the growth stages from the distinguishing features.

14. The identification processing method according to claim 13, wherein:
the second page further displays second similar images, wherein labels corresponding to the second similar images comprise the classifications similar to the classifications from the distinguishing features, wherein the second similar images are displayed less prominently in the second page compared to the second output image.

15. The identification processing method according to claim 13, wherein:
the specific operation is an operation performed on an operable region corresponding to the other growth stages in the first page.

16. The identification processing method according to claim 1, wherein:
the growth stages of the plant comprise a just-emerged seedling stage, a small seedling stage, a leaf stage, a blooming stage, a fruiting stage, a leaf-falling stage, and a dormant stage.

17. The identification processing method according to claim 4, wherein:
a plant part comprises trunk, bud, seed, flower bud, fruit, and seedling.

18. An identification processing method for plant images, comprising:
acquiring an input image associated with a plant, and determining distinguishing features of the plant according to a trained image identification model, the distinguishing features comprising classifications and growth stages of the plant;
acquiring candidate images and labels corresponding to each of the candidate images, wherein the labels comprise the classifications and the growth stages of the plant in the each of the candidate images; and
selecting, from the candidate images, a candidate image having corresponding labels comprising the classifications and the growth stages from the distinguishing features, as well as comprising the classifications from the distinguishing features and other growth stages different from the growth stages from the distinguishing features as an output image to be displayed in a page.

19. The identification processing method according to claim 18, wherein:
each of the output image is configured to be operable to change a display position thereof in the page.

20. The identification processing method according to claim 19, wherein
an operation comprises clicking and/or sliding via an input device.

21. The identification processing method according to claim 18, wherein:
prioritizing display of the output image having the corresponding labels comprising the classifications and the growth stages from the distinguishing features as a current image, and configuring output images having corresponding labels comprising the classifications and the other growth stages from the distinguishing operation to be displayed in response to a specific operation.

22. The identification processing method according to claim 21, wherein:
in response to none of the labels corresponding to each of the candidate images whose the labels comprise the classifications from the distinguishing features contain the growth stages from the distinguishing features, the input image is used as the current image.

23. The identification processing method according to claim 21, wherein:
the output image having the corresponding labels comprising the classifications and the other growth stages from the distinguishing features are arranged such that the following are arranged close to the current image:
the corresponding labels thereof comprise a popular growth stage corresponding to a respective classification, wherein the popular growth stage is determined based on the number of times each of the growth stages of the classifications is identified in each of historically identified input images; or
the corresponding labels thereof comprise growth stages corresponding to robust identification features of a respective classification.

24. An identification processing system for plants, comprising:
one or more processors; and
one or more memories, wherein the one or more memories are configured to store a series of computer-executable instructions and computer-accessible data associated with the series of computer-executable instructions,
wherein, when executed by the one or more processors, the series of computer-executable instructions enable the one or more processors to execute the method according to claim 1.

25. A non-transitory computer-readable storage medium, which stores a series of computer-executable instructions that, when executed by one or more computing devices, enable the one or more computing devices to execute the method according to claim 1.
